(19) United States
(12) Patent Application Publication
(10) Pub. No.: US 2016/0144627 A1
(43) Pub. Date: May 26, 2016

(54) CLEANING DEVICE

(71) Applicant: FUJIFILM Corporation, Tokyo (JP)

(72) Inventors: Yuichi OZAKI, Kanagawa (JP); Takami ARAKAWA, Kanagawa (JP); Yasukazu NIHEI, Kanagawa (JP)

(73) Assignee: FUJIFILM Corporation, Tokyo (JP)

(21) Appl. No.: 15/010,779

(22) Filed: Jan. 29, 2016

Related U.S. Application Data
(63) Continuation of application No. PCT/JP2014/068026, filed on Jul. 7, 2014.

(30) Foreign Application Priority Data
Aug. 6, 2013 (JP) 2013-163085

(51) Int. Cl. B41J 2/165

(52) U.S. Cl. CPC B41J 2/16552

(57) ABSTRACT

Provided is a cleaning device that can reduce maintenance-time while injecting a cleaning solution into a gap between head modules so that the cleaning solution or the like is not sucked into an inkjet head. The position of the inkjet head relative to a spray-nozzle is moved in one direction. When relative movement is performed, the relative movement is temporarily stopped or moving speed of the relative movement is reduced at a position where the gap between the head modules faces at least the spray-nozzle. The cleaning solution is sprayed to the gap at a time when the relative movement is temporarily stopped or when the moving speed of the relative movement is reduced. A removing member removing the cleaning solution present in the gap, is provided at a position separated from the spray-nozzle in the one direction by a distance of n times a pitch of the gaps.

### CROSS-REFERENCE TO RELATED APPLICATIONS

This application is a Continuation of PCT International Application No. PCT/JP2014/068026 filed on Jul. 7, 2014, which claims priority under 35 U.S.C §119(a) to Japanese Patent Application No. 2013-163085 filed Aug. 6, 2013. Each of the above application(s) is hereby expressly incorporated by reference, in its entirety, into the present application.

### BACKGROUND OF THE INVENTION

1. Field of the Invention

The present invention relates to a cleaning device that cleans a gap between head modules of an ink jet head.

2. Description of the Related Art

An ink jet recording apparatus, which includes a so-called full-line type ink jet head in which nozzles are provided over a length corresponding to the entire width of a recording medium, is well known as an ink jet recording apparatus that forms a color image on a recording medium. In such an ink jet recording apparatus, an image can be formed at a high speed using a so-called single-pass method in which a recording medium and an ink jet head are moved relative to each other one time to form a color image over the entire image forming region of the recording medium.

A full-line type ink jet head has a structure in which a plurality of head modules are joined to each other. Improvement of accuracy in manufacture or the improvement of manufacturing yield is expected from such an ink jet head improves accuracy in manufacture or improves manufacturing yield. Further, in case this ink jet head is rejected in check at the time of manufacture, the ink jet head is out of order, or the ink jet head needs to be replaced due to the end of the service life thereof, there is a merit that each head module can be replaced.

Meanwhile, a gap, which is caused by a manufacturing error of each head module or a positioning error during assembly, is formed between the head modules of the ink jet head in which the plurality of head modules are joined to each other. Dirt, such as ink (ink mist), which is scattered when ink is ejected from the nozzles, or paper powder, adheres to the gap. For this reason, it is necessary to regularly clean the gap between the head modules.

JP2010-5857A discloses a head maintenance device that cleans a gap by removing and absorbing a cleaning solution, which is injected into a gap by a capillary force, by a porous member after applying the cleaning solution to an ink ejection surface of an ink jet head (each head module) by a cleaning solution applying roller.

JP2012-157983A discloses a nozzle surface cleaning device that cleans an ink ejection surface by wiping the ink ejection surface with a web unit after applying a cleaning solution to the ink ejection surface of an ink jet by a cleaning solution applying roller. Further, JP2005-28758A discloses a head cleaning device that cleans an ink ejection surface by spraying a cleaning solution, to which pressure and ultrasonic vibration are applied, to the ink ejection surface of an ink jet head from a nozzle. Since the cleaning solution, which is applied or sprayed to the ink ejection surface, can be injected into a gap by a capillary force, the gap can be cleaned.

### SUMMARY OF THE INVENTION

However, since the cleaning solution is applied or sprayed to the entire ink ejection surface in the inventions disclosed in JP2010-5857A, JP2012-157983A, and JP2005-28758A, there is a concern that air bubbles or the cleaning solution may be sucked into the ink jet head.

Further, in the invention disclosed in JP2010-5857A, slits are formed on the cleaning solution applying roller so that the cleaning solution is not applied to the gap positioned on the upstream side in a head moving direction by the cleaning solution applying roller in case the cleaning solution, which is present in the gap positioned on the downstream side in the head moving direction among adjacent gaps, is absorbed by the porous member. For this reason, the injection of the cleaning solution into the gap, which is positioned on the downstream side in the head moving direction, and the application of the cleaning solution to the gap, which is positioned on the upstream side in the head moving direction, cannot be simultaneously performed in the invention disclosed in JP2010-5857A. Accordingly, in case of processing for cleaning only the gap between the head modules is performed by using the invention disclosed in JP2010-5857A, it is necessary to separately perform the injection of the cleaning solution into the gap, which is positioned on the downstream side in the head moving direction, and the application of the cleaning solution to the gap that is positioned on the upstream side in the head moving direction. For this reason, long time is required for maintenance.

An object of the invention is to provide a cleaning device that can reduce maintenance time while injecting a cleaning solution into a gap between head modules so that air bubbles or the cleaning solution is not sucked into an ink jet head.

In order to achieve the object of the invention, there is provided a cleaning device including: a spray nozzle that can spray a cleaning solution to an ink ejection surface of an ink jet head in which a plurality of head modules are joined to each other in one direction; a relative movement unit that moves the position of the ink jet head relative to the spray nozzle in the one direction; a movement controller that temporarily stops relative movement performed by the relative movement unit or reduces moving speed of the relative movement at a position where a gap between the head modules faces at least the spray nozzle in a case in which the relative movement performed by the relative movement unit is performed; a nozzle controller that allows the cleaning solution to be sprayed to the gap from the spray nozzle at a time in case in which the relative movement performed by the relative movement unit is temporarily stopped or at a time in a case in which the moving speed of the relative movement is reduced; and a removing member that is disposed at a position separated from the spray nozzle in the one direction by a distance of n (n is a natural number of 1 or more) times a pitch of the gaps and removes the cleaning solution present in the gap.

According to the invention, in a case in which the gap between the head modules is present at a position facing the spray nozzle, the cleaning solution is sprayed to the gap from the spray nozzle. Accordingly, it is not necessary to apply or spray the cleaning solution to the entire ink ejection surface. For this reason, the suction of air bubble or the cleaning solution into the ink jet head is prevented. Further, since the removing member is disposed at a position separated from the spray nozzle in one direction by a distance of n times the pitch of the gaps, the spray of the cleaning solution to the gap, which is performed by the spray nozzle, and the removal of the cleaning solution present in the gap, which is performed by the removing member, can be simultaneously performed in parallel. As a result, while the cleaning solution is injected into each gap, maintenance time can be reduced.

It is preferable that the movement controller temporarily stops the relative movement, which is performed by the relative movement unit, or reduces the moving speed of the relative movement at a position where the gap faces the removing member. Accordingly, the spray of the cleaning solution to the gap, which is performed by the spray nozzle, and the removal of the cleaning solution present in the gap, which is performed by the removing member, can be simultaneously performed in parallel.

It is preferable that the removing member is a first absorption member coming into contact with the ink ejection surface and absorbing the cleaning solution present in at least the gap. Accordingly, it is possible to absorb and remove the cleaning solution, which remains in the gap, by the first absorption member.

It is preferable that the first absorption member is in a dry state. Accordingly, the amount of the cleaning solution to be absorbed by the first absorption member and the absorption speed of the cleaning solution can be increased. Meanwhile, the “dry state”, which is mentioned here, is a state in which liquid is not absorbed into the first absorption member, and specifically means that the amount of the cleaning solution absorbed into the first absorption member is in the range of, for example, 0 to 20% of the amount of the cleaning solution to be absorbed in a saturation state. In contrast, a “wet state”, which is mentioned below, is a state in which liquid is absorbed into the first absorption member being in the dry state, and specifically means that the amount of the cleaning solution absorbed into the first absorption member is in the range of, for example, 20 to 100% of the amount of the cleaning solution to be absorbed in a saturation state.

It is preferable that the first absorption member is in a wet state. For this reason, since liquid retained in the first absorption member is joined to the cleaning solution present in the gap, the cleaning solution present in the gap can be reliably absorbed.

In a case in which the period of time during which the first absorption member comes into contact with the gap is denoted by T, the period of time during which the relative movement is temporarily stopped is denoted by Ts, an absorption volume of the cleaning solution, which is absorbed into the first absorption member per unit time, is denoted by Qs, and the volume of the cleaning solution present in the gap is denoted by Qg in a case in which the movement controller temporarily stops the relative movement that is performed by the relative movement unit, it is preferable that the movement controller controls the relative movement unit so that “T=Ts≧(Qg/Qs)” is satisfied. Accordingly, it is possible to ensure the amount of absorption time that is just enough to absorb the cleaning solution present in the gap.

In a case in which the period of time during which the first absorption member comes into contact with the gap is denoted by T, the moving speed of the relative movement at the time of deceleration is denoted by V, and a width of the gap in the one direction is denoted by W in a case in which the movement controller reduces the moving speed of the relative movement that is performed by the relative movement unit, it is preferable that the movement controller controls the relative movement unit so that “T=(W/V)≧(Qg/Qs)” is satisfied. Accordingly, it is possible to ensure the amount of absorption time that is just enough to absorb the cleaning solution present in the gap.

It is preferable that the cleaning device further includes a second absorption member that is disposed at a position separated from the removing member in the one direction by a distance of m (m is a natural number of 1 or more) times the pitch, comes into contact with the ink ejection surface, and is in a wet state. Accordingly, it is possible to recover the meniscuses of ink that is present in the nozzles of the head module.

It is preferable that the relative movement unit can move the position of the ink jet head relative to the spray nozzle in the one direction and the other direction opposite to the one direction; the cleaning device further includes a wipe controller that allows the first absorption member to come into contact with the ink ejection surface after making the first absorption member be in a wet state in a case in which the first absorption member is in a dry state and allows the first absorption member to come into contact with the ink ejection surface in a case in which the first absorption member is in a wet state, after the cleaning solution is sprayed to the gap by the spray nozzle and the cleaning solution present in the gap is removed by the first absorption member; and the movement controller performs the relative movement performed by the relative movement unit while the first absorption member being in a wet state comes into contact with the ink ejection surface after the cleaning solution is sprayed to the gap by the spray nozzle and the cleaning solution present in the gap is removed by the first absorption member. Accordingly, it is possible to recover the meniscuses of ink that is present in the nozzles of the head module.

It is preferable that the cleaning device further includes a cleaning solution film-forming portion provided at a tip portion of the spray nozzle. The cleaning solution film-forming portion includes: a parallel surface that faces the ink ejection surface, is parallel to the ink ejection surface, and has a shape corresponding to the gap; and a communication hole that is opened to the parallel surface and communicates with a spray hole of the spray nozzle for the cleaning solution. The cleaning solution film-forming portion forms a film of the cleaning solution between the ink ejection surface and the parallel surface in a case in which the cleaning solution is sprayed from the spray hole. Accordingly, it is possible to inject the cleaning solution into the gap by a capillary force.

It is preferable that the spray nozzle includes one spray hole spraying the cleaning solution and sprays the cleaning solution to one point in the gap from the spray hole. Accordingly, it is possible to inject the cleaning solution into the gap using an inertial force.

It is preferable that a plurality of spray holes spraying the cleaning solution are formed at the spray nozzle in a direction parallel to the gap. Accordingly, a large amount of the cleaning solution can be injected over a large area in the gap.

According to the cleaning device of the invention, it is possible to reduce maintenance time while injecting a cleaning solution into a gap between head modules so that air bubbles or the cleaning solution is not sucked into an ink jet head.

### BRIEF DESCRIPTION OF THE DRAWINGS

FIG. 1 is a schematic view of a gap cleaning device corresponding to a cleaning device of the invention.

FIG. 2 is a view showing the disposition of a spray hole of a spray nozzle.

FIG. 3 is a view showing the disposition of another embodiment of spray holes of the spray nozzle.

FIG. 4 is a schematic view of a first absorption unit of another embodiment that uses a wet web.

FIG. 5 is a flowchart illustrating a flow of cleaning processing of the gap cleaning device.

FIG. 6 is a view illustrating the flow of the cleaning processing of the gap cleaning device.

FIG. 7 is a schematic view of a spray nozzle of another embodiment that forms a cleaning solution film.

FIG. 8 is a schematic view of a spray nozzle of another embodiment that sprays a cleaning solution on one point of a gap.

FIG. 9 is a schematic view of an ink jet recording apparatus that includes the gap cleaning device.

FIG. 10 is a view showing a disposition relationship between a printing section and a maintenance processing section of the ink jet recording apparatus.

FIG. 11 is a block diagram showing the electric configuration of the ink jet recording apparatus.

FIG. 12 is a schematic view showing an ink jet recording apparatus of another embodiment that employs an impression cylinder-conveyance system.

FIG. 13 is a schematic view showing a gap cleaning device of another embodiment that performs finish wiping by using a first absorption unit.

FIG. 14 is a view illustrating a flow of cleaning processing of a gap cleaning device of another embodiment.

### DESCRIPTION OF THE PREFERRED EMBODIMENTS

### Configuration of Gap Cleaning Device

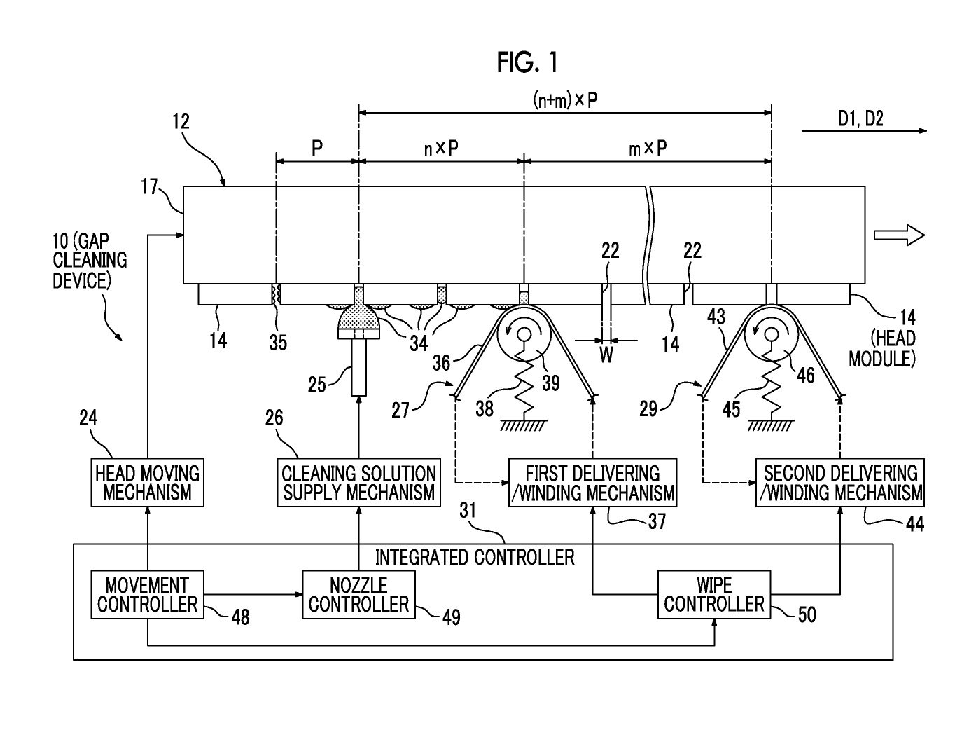

As shown in FIG. 1, a gap cleaning device 10 corresponding to a cleaning device of the invention is used to clean a gap 22 between head modules 14 of an ink jet head 12.

The ink jet head 12 is a full-line type ink jet head, and is adapted so that a plurality of head modules 14 are joined to each other in a longitudinal direction D1 of the ink jet head (corresponding to one direction in the invention). The ink jet head 12 includes the plurality of head modules 14 and a head module holder 17 that holds the respective head modules 14.

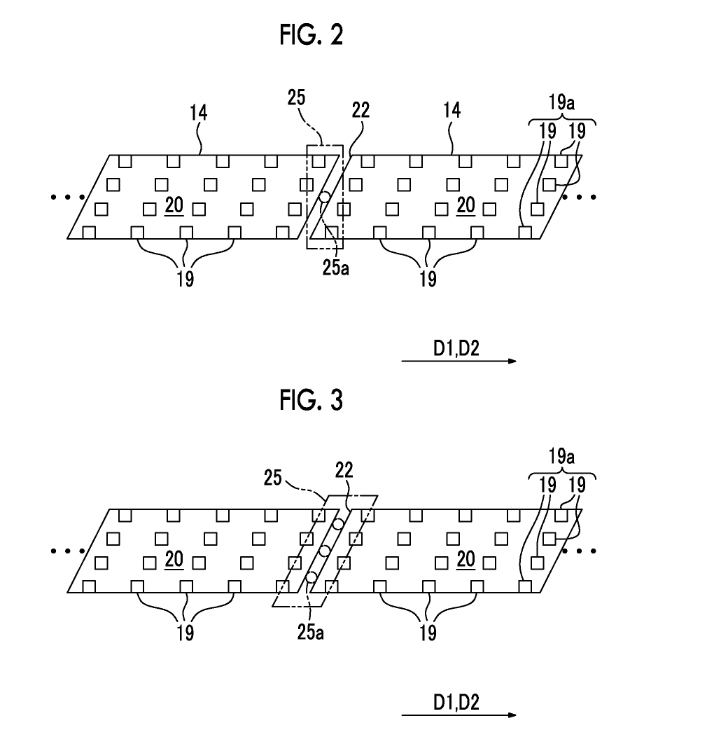

Each of the head modules 14 includes an ink ejection surface (referred to as a nozzle surface) 20 on which nozzles 19 for ejecting ink (liquid) are formed (see FIG. 2). Nozzle arrays 19a (see FIG. 2), each of which includes the plurality of nozzles 19 arranged in a direction inclined with respect to the longitudinal direction D1 by a constant angle, are formed on the ink ejection surface 20. Further, a plurality of the nozzle arrays 19a are arranged in the longitudinal direction D1.

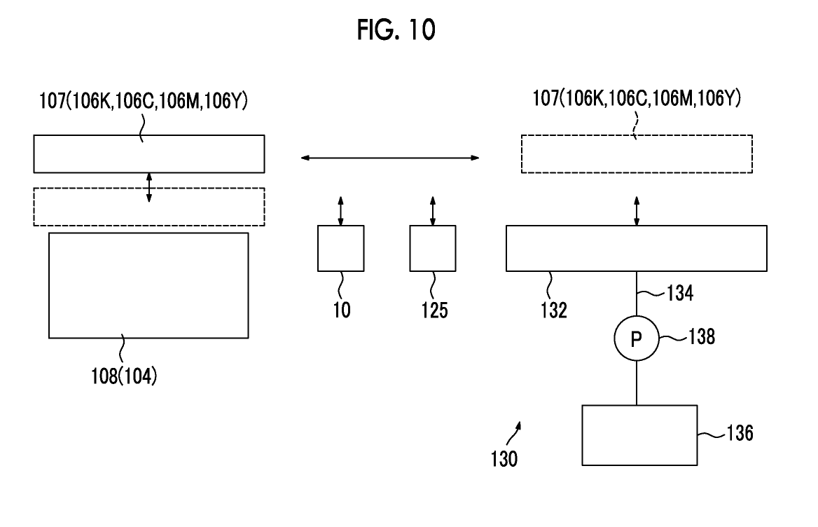

The gap cleaning device 10 is provided on the conveying path of the ink jet head 12 between a printing section and a maintenance processing section of an ink jet recording apparatus (see FIG. 10). The gap cleaning device 10 cleans the gap 22 between the head modules 14 of the ink jet head 12 that is moved in a head moving direction D2 (one direction) parallel to the longitudinal direction D1. The width W of the gap 22 (the length of the gap in the head moving direction) is determined according to the density of the disposed nozzles 19.

The gap cleaning device 10 mainly includes a head moving mechanism (relative movement unit) 24, a spray nozzle 25, a cleaning solution supply mechanism 26, a first absorption unit 27, a second absorption unit 29, and an integrated controller 31.

The head moving mechanism 24 conveys the ink jet head 12 to the maintenance processing section from the printing section of the ink jet recording apparatus in the head moving direction D2 (see FIG. 10). Accordingly, the position of the ink jet head 12 relative to the spray nozzle 25, the first absorption unit 27, and the second absorption unit 29 is moved in the head moving direction D2 (the longitudinal direction D1).

Meanwhile, the ink jet head 12 is moved in the head moving direction D2 by the head moving mechanism 24 in this embodiment, but a moving mechanism (a relative movement unit), which moves the spray nozzle 25, the first absorption unit 27, and the second absorption unit 29 in a direction opposite to the head moving direction D2, may be provided instead of the head moving mechanism 24. Even in this case, the position of the ink jet head 12 relative to the spray nozzle 25, the first absorption unit 27, and the second absorption unit 29 can be moved in the head moving direction D2 (the longitudinal direction D1).

Since the spray nozzle 25 is disposed at a position that faces the ink ejection surface 20 of the ink jet head 12 conveyed by the head moving mechanism 24, the spray nozzle 25 sprays a cleaning solution 34 onto the ink ejection surface 20. The spray nozzle 25 sprays the cleaning solution 34 to the gap 22 at the time in a case in which the spray nozzle 25 is conveyed by the head moving mechanism 24 and moved to a position where each gap 22 faces the spray nozzle 25. The cleaning solution 34, which is sprayed to the gap 22, is injected into the gap 22 by a capillary force. Since the cleaning solution 34 is injected into the gap 22 and processing for cleaning the inside of the gap 22 (rinsing processing) is performed, mist 35 or the like adhering to wall surfaces of the head modules 14 forming the gap 22 is removed from the wall surfaces.

As shown in FIG. 2, the tip portion of the spray nozzle 25 has a shape that is elongated in a direction parallel to the ink ejection surface 20 and orthogonal to the head moving direction D2 (the longitudinal direction D1), and one spray hole 25a for spraying the cleaning solution 34 is formed at the center of the tip portion of the spray nozzle 25. Accordingly, the cleaning solution 34 is sprayed to the gap 22 from the one spray hole 25a.

Here, as shown in FIG. 3, the tip portion of the spray nozzle 25 is formed in a shape that is elongated in a direction parallel to the ink ejection surface 20 and parallel to the gap 22 (a longitudinal direction of the gap 22), and a plurality of spray holes 25a are formed in the direction parallel to the gap 22. Accordingly, since the cleaning solution 34 can be sprayed to the gap 22 from the plurality of the spray holes 25a, a large amount of the cleaning solution 34 can be injected over a large area in the gap 22. Therefore, since the one spray hole 25a is formed in the spray nozzle 25 shown in FIG. 2, costs can be reduced. In contrast, since the plurality of the spray holes 25a are formed in the spray nozzle 25 shown in FIG. 3, the area of a region to be cleaned is increased and cleaning time can be reduced.

Returning to FIG. 1, the cleaning solution supply mechanism 26 supplies the cleaning solution 34 to the spray nozzle 25 under a command from the integrated controller 31. Although not shown, the cleaning solution supply mechanism 26 includes, for example, a tank that stores a cleaning solution 34, a pipeline that connects the tank to the spray nozzle 25, and a pump or an electromagnetic valve that is provided on the pipeline.

The first absorption unit 27 is disposed at a position that is separated from the spray nozzle 25 on the downstream side in the head moving direction D2 by a distance of n (n is a natural number of 1 or more) times a pitch P of the head modules 14. The first absorption unit 27 includes a first delivering/winding mechanism 37 for storing a dry web (a removing member, a first absorption member) 36 that is a web in a dry state, a biasing member 38 such as a spring, and a pressing roller 39.

The dry web 36 has a width corresponding to the width (the length in a direction orthogonal to D1 and D2 in FIG. 2) of each head module 14. The first delivering/winding mechanism 37 includes a delivery shaft and a winding shaft for the dry web 36; and delivers the dry web 36 from the delivery shaft and winds the delivered dry web 36 by the winding shaft. The pressing roller 39 receives a biasing force from the biasing member 38 and presses the dry web 36 against the ink ejection surface 20 or the gap 22.

The first absorption unit 27 conveys the dry web 36 in a direction opposite to the head moving direction D2 by the first delivering/winding mechanism 37 while pressing the dry web 36 against the ink ejection surface 20 or the gap 22 by the pressing roller 39 during the conveyance of the ink jet head 12 performed by the head moving mechanism 24.

Accordingly, the cleaning solution 34, which remains on the ink ejection surface 20 (particularly, the peripheral portion of the gap 22) due to the spray of the cleaning solution 34 from the spray nozzle 25, is wiped off by the dry web 36. Further, the cleaning solution 34 remaining in the gap 22 is absorbed into the dry web 36. Since the dry web 36 is used to wipe the cleaning solution 34 off or to absorb the cleaning solution 34, the amount of the cleaning solution 34 to be absorbed and the absorption speed of the cleaning solution 34 can be increased.

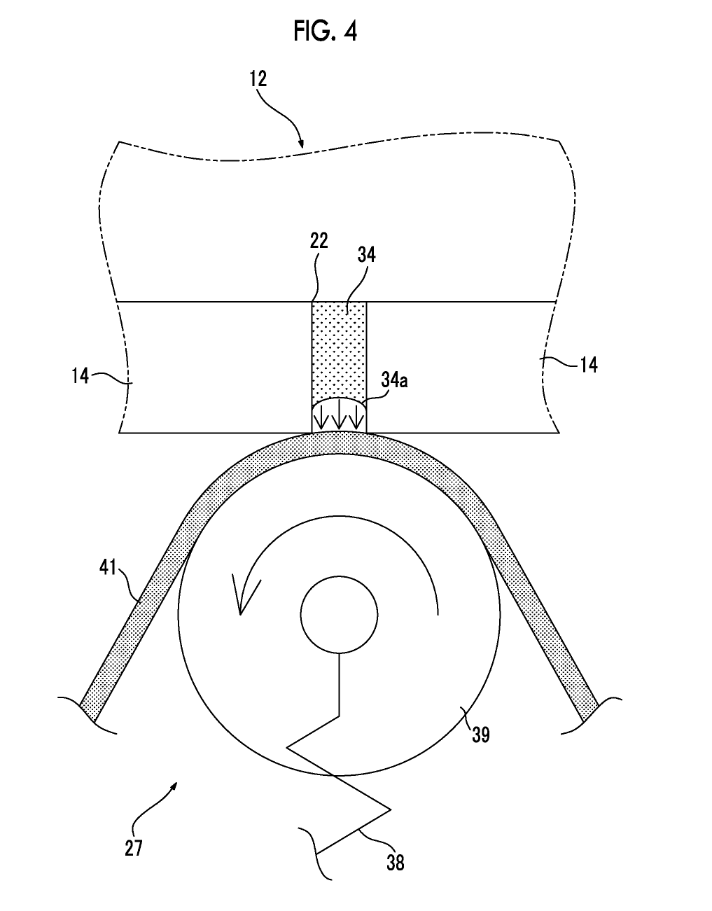

Here, the first absorption unit 27 wipes the cleaning solution 34 off or absorbs the cleaning solution 34 by using the dry web 36. However, the first absorption unit 27 may wipe the cleaning solution 34 off by using a wet web 41 (see FIG. 4), which is a web in a wet state, instead of the dry web 36.

In a case in which a meniscus 34a of the cleaning solution 34, which remains in the gap 22, is a curved surface that is curved away from the first absorption unit 27 (upward in FIG. 4) as shown in FIG. 4, the dry web 36 or the wet web 41 cannot come into direct contact with the cleaning solution 34 remaining in the gap 22. Meanwhile, in FIG. 4, the size of a gap between the cleaning solution 34, which remains in the gap 22, and the wet web 41 is exaggerated in comparison with the actual size thereof. In this case, the dry web 36 cannot absorb the cleaning solution 34 remaining in the gap 22 so long as the dry web 36 does not come into contact with the cleaning solution 34 remaining in the gap 22. Meanwhile, in a case in which the wet web 41 is used, liquid retained in the wet web 41 and the cleaning solution 34 remaining in the gap 22 are joined to each other even though the wet web 41 does not direct come into contact with the cleaning solution 34 remaining in the gap 22. Accordingly, the cleaning solution 34 remaining in the gap 22 is reliably absorbed into the wet web 41.

Returning to FIG. 1, the second absorption unit 29 is disposed at a position that is separated from the first absorption unit 27 on the downstream side in the head moving direction D2 by a distance of m (m is a natural number of 1 or more) times the pitch P, that is, a position that is separated from the first spray nozzle 25 on the downstream side in the head moving direction D2 by a distance of (n+m)×P. The second absorption unit 29 has basically the same configuration as the first absorption unit 27, and includes a second delivering/winding mechanism 44 that stores a wet web (a second absorption member) 43, a biasing member 45 such as a spring, and a pressing roller 46.

The second absorption unit 29 performs so-called finish wiping for wiping the ink ejection surface 20 (particularly, the peripheral portion of the gap 22) by using the wet web 43. There is a concern that the meniscuses of ink present in the nozzles 19 provided particularly at the peripheral portion of the gap 22 may be broken in the wiping performed by the above-mentioned first absorption unit 27. For this reason, it is possible to recover the meniscus of ink, which is present in the nozzle 19, by performing finish wiping by the wet web 43.

The integrated controller 31 integrally controls the operation of each part of the gap cleaning device 10. The integrated controller 31 is provided with a movement controller 48, a nozzle controller 49, and a wipe controller 50.

The movement controller 48 controls the head moving mechanism 24 to convey the ink jet head 12 to the maintenance processing section from the printing section of the ink jet recording apparatus in the head moving direction D2 (see FIG. 10). In this case, the movement controller 48 obtains, for example, information about the position of the ink jet head 12 from the printing section on the basis of the conveying speed of the ink jet head 12 that is conveyed by the head moving mechanism 24. Further, the movement controller 48 tracks the position of each gap 22 between the head modules 14 on the basis of the obtained information about the position of the ink jet head 12 and known dimensions of each part of the ink jet head 12.

Meanwhile, a method of tracking the position of each gap 22 is not particularly limited, and various methods may be used as the method of tracking the position of each gap 22. For example, a detection sensor for detecting the position of the ink jet head 12 is provided and the position of each gap 22 may be tracked on the basis of the detection result of the detection sensor and known dimensions of each part of the ink jet head 12. The movement controller 48 outputs the result of the tracking of the position of each gap 22 to the nozzle controller 49 and the wipe controller 50.

After that, the movement controller 48 temporarily stops the conveyance of the ink jet head 12, which is performed by the head moving mechanism 24, or reduces the conveying speed (moving speed) of the ink jet head 12 at a position where each gap 22 faces the spray nozzle 25 on the basis of the result of the tracking of the position of each gap 22 during the conveyance of the ink jet head 12. Meanwhile, the position where the gap 22 faces the spray nozzle 25, which is mentioned here, also includes a position in the vicinity of the position where the gap 22 faces the spray nozzle 25. Accordingly, the ink jet head 12 is temporarily stopped or is conveyed so as to decelerate at a position where the gap 22 faces the spray nozzle 25 in order from the gap 22 that is positioned on the most downstream side in the head moving direction. Hereinafter, the gap 22, which is positioned on the most downstream side in the head moving direction (the right side in FIG. 1), is abbreviated as “the first gap 22”, and the gap 22, which is positioned on the most upstream side in the head moving direction (the left side in FIG. 1), is abbreviated as “the last gap 22”.

In this case, an interval between the spray nozzle 25 and the first absorption unit 27 is n×P. For this reason, in a case in which the (n+1)th or subsequent gap 22 from the downstream side in the head moving direction is temporarily stopped or is conveyed so as to decelerate at a position where the gap 22 faces the spray nozzle 25, another gap 22, which is present at a position separated from this gap 22 on the downstream side in the head moving direction by a distance of n×P, is temporarily stopped or is conveyed so as to decelerate at a position facing the first absorption unit 27 (including a position in the vicinity thereof). That is, the injection of the cleaning solution 34 into the gap 22 that is performed by the spray nozzle 25 and the absorption of the cleaning solution 34 of the gap 22 that is performed by the first absorption unit 27 are simultaneously performed in parallel.

Further, an interval between the spray nozzle 25 and the second absorption unit 29 is (n+m)×P. For this reason, in a case in which the (n+m+1)th or subsequent gap 22 from the downstream side in the head moving direction is temporarily stopped or is conveyed so as to decelerate at a position where the gap 22 faces the spray nozzle 25, another gap 22, which is present at a position separated from this gap 22 on the downstream side in the head moving direction by a distance of (n+m)×P, is temporarily stopped or is conveyed so as to decelerate at a position facing the second absorption unit 29 (including a position in the vicinity thereof). That is, the injection of the cleaning solution 34 into the gap 22 that is performed by the spray nozzle 25, the absorption of the cleaning solution 34 of the gap 22 that is performed by the first absorption unit 27, and finish wiping that is performed by the second absorption unit 29 are simultaneously performed in parallel.

Furthermore, the movement controller 48 continues to temporarily stop the conveyance of the ink jet head 12 or to reduce the conveying speed of the ink jet head 12 even after the last gap 22 passes by the spray nozzle 25. Specifically, in case the gap 22, which does not yet pass by the first absorption unit 27 and the second absorption unit 29, is conveyed to a position facing each of the first absorption unit 27 and the second absorption unit 29, the movement controller 48 controls the head moving mechanism 24 to temporarily stop the conveyance of the ink jet head 12 or to reduce the conveying speed of the ink jet head 12. Accordingly, the movement controller 48 temporarily stops the conveyance of the ink jet head 12, which is performed by the head moving mechanism 24, or reduces the conveying speed of the ink jet head 12 at a position where the each gap 22 faces at least one of the spray nozzle 25, the first absorption unit 27, and the second absorption unit 29.

The movement controller 48 determines stop time, during which the movement controller 48 temporarily stops the conveyance of the ink jet head 12, according to the absorption capacity of the first absorption unit 27 (the dry web 36 or the wet web 41) for the cleaning solution 34.

Specifically, the period of time during which the dry web 36 (or the wet web 41) comes into contact with the gap 22 is denoted by T; the period of time during which the conveyance of the ink jet head 12 is temporarily stopped is denoted by Ts; the absorption volume of the cleaning solution 34, which is absorbed into the dry web 36 (or the wet web 41) per unit time, is denoted by Qs; and the volume of the cleaning solution 34 present in the gap 22 is denoted by Qg. In this case, the movement controller 48 determines Ts so that “T=Ts≧(Qg/Qs)” is satisfied and controls the head moving mechanism 24. Meanwhile, the absorption volume Qs for the dry web 36 (or the wet web 41) is a known value, and the volume Qg of the cleaning solution 34 present in the gap 22 can be determined by experiments or simulations. Accordingly, it is possible to temporarily stop the conveyance of the ink jet head 12 for only the amount of time that is required for the first absorption unit 27 to absorb the cleaning solution 34 present in the gap 22. That is, it is possible to ensure the amount of absorption time that is just enough to absorb the cleaning solution 34 present in the gap 22. As a result, the injection of the cleaning solution 34 into the gap 22 that is performed by the spray nozzle 25 and the absorption of the cleaning solution 34 of the gap 22 that is performed by the first absorption unit 27 can be simultaneously performed in parallel.

Further, the movement controller 48 also determines speed, in a case in which the movement controller 48 reduces the conveying speed of the ink jet head 12, according to the absorption capacity of the first absorption unit 27 (the dry web 36 or the wet web 41) for the cleaning solution 34. Specifically, in a case in which the period of time during which the dry web 36 (or the wet web 41) comes into contact with the gap 22 is denoted by T, conveying speed at the time of deceleration is denoted by V, and the width of the gap 22 (the length of the gap in the head moving direction) is denoted by W, the movement controller determines V so that “T=(W/V)≧(Qg/Qs)” is satisfied and controls the head moving mechanism 24. Meanwhile, the period of time during which the ink jet head 12 is conveyed so that the speed of the ink jet head 12 is reduced to the conveying speed V is appropriately adjusted according to the conveying speed V, the absorption capacity of the first absorption unit 27, the width W of the gap 22, or the like. Accordingly, it is possible to ensure the amount of time that is required for the first absorption unit 27 to absorb the cleaning solution 34 present in the gap 22. That is, it is possible to ensure the amount of absorption time that is just enough to absorb the cleaning solution 34 present in the gap 22. As a result, the injection of the cleaning solution 34 into the gap 22 that is performed by the spray nozzle 25 and the absorption of the cleaning solution 34 of the gap 22 that is performed by the first absorption unit 27 can be simultaneously performed in parallel.

The nozzle controller 49 controls the cleaning solution supply mechanism 26 to control the spray of the cleaning solution 34 from the spray nozzle 25. Specifically, in a case in which each gap 22 is moved to a position where the gap 22 faces the spray nozzle 25, the nozzle controller 49 controls the cleaning solution supply mechanism 26 on the basis of the result of the tracking of the position of each gap 22, which is acquired from the movement controller 48, to allow the cleaning solution 34 to be sprayed from the spray nozzle 25. Accordingly, the cleaning solution 34 is sprayed to the gap 22, which is temporarily stopped or is conveyed so as to decelerate at a position where the gap 22 faces the spray nozzle 25, from the spray nozzle 25.

The wipe controller 50 controls the operation of each of the first delivering/winding mechanism 37 and the second delivering/winding mechanism 44 to individually control the conveyance/stop of each of the dry web 36 (or the wet web 41) and the wet web 43.

Specifically, the wipe controller 50 operates the first delivering/winding mechanism 37 on the basis of the result of the tracking of the position of each gap 22, which is acquired from the movement controller 48, while all the gaps 22 pass by the first absorption unit 27. For example, the wipe controller 50 operates the first delivering/winding mechanism 37 before a predetermined amount of time from the time in a case in which the first gap 22 passes by the first absorption unit 27, and stops the operation of the first delivering/winding mechanism 37 after a predetermined amount of time passes from the time in a case in which the last gap 22 passes by the first absorption unit 27. Accordingly, the cleaning solution 34, which remains on the ink ejection surface 20 (particularly, the peripheral portion of the gap 22) due to the spray of the cleaning solution 34 from the spray nozzle 25, is wiped off by the dry web 36 (or the wet web 41). Further, the cleaning solution 34, which remains in the gap 22, is absorbed into the dry web 36 (or the wet web 41).

Furthermore, the wipe controller 50 operates the second delivering/winding mechanism 44 on the basis of the result of the tracking of the position of each gap 22 while all the gaps 22 pass by the second absorption unit 29. For example, the wipe controller 50 operates the second delivering/winding mechanism 44 before a predetermined amount of time from the time in a case in which the first gap 22 passes by the second absorption unit 29, and stops the operation of the second delivering/winding mechanism 44 after a predetermined amount of time passes from the time in a case in which the last gap 22 passes by the second absorption unit 29. Accordingly, the finish wiping of the ink ejection surface 20 (particularly, the peripheral portion of the gap 22) is performed by the wet web 43.

Meanwhile, the wipe controller 50 always operates the first delivering/winding mechanism 37 and the second delivering/winding mechanism 44 while each gap 22 passes by the first absorption unit 27 and the second absorption unit 29, respectively. In contrast, for example, the wipe controller 50 may operate the first delivering/winding mechanism 37 and the second delivering/winding mechanism 44 only in case each gap 22 is moved to a position facing the first absorption unit 27 and the second absorption unit 29, respectively. That is, only each gap 22 and the peripheral portion thereof may be wiped by the dry web 36 (or the wet web 41) and the wet web 43, respectively. Further, in case each gap 22 is moved to a position facing the first absorption unit 27 and the second absorption unit 29, the wipe controller 50 may control the first delivering/winding mechanism 37 and the second delivering/winding mechanism 44, respectively, so that the conveying speeds of the dry web 36 (or the wet web 41) and the wet web 43 are increased.

[Action of Gap Cleaning Device]

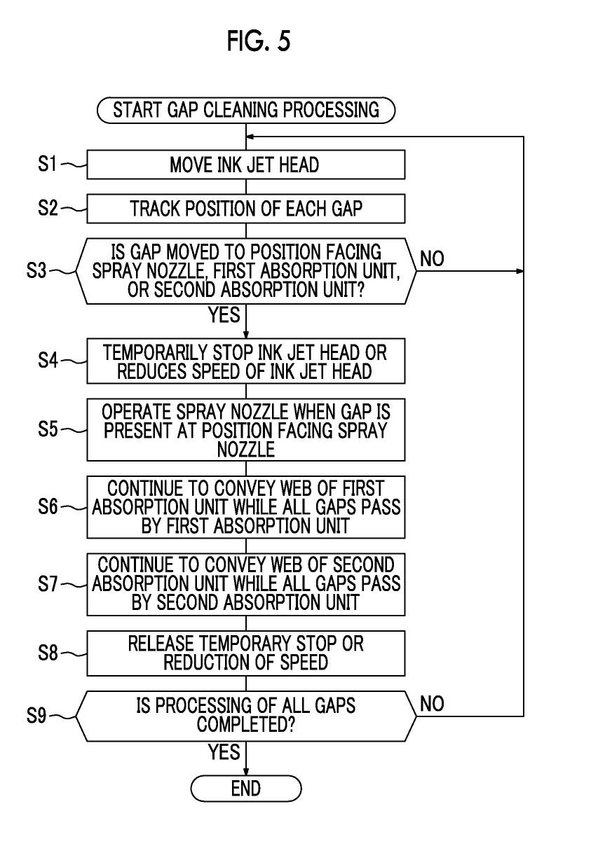

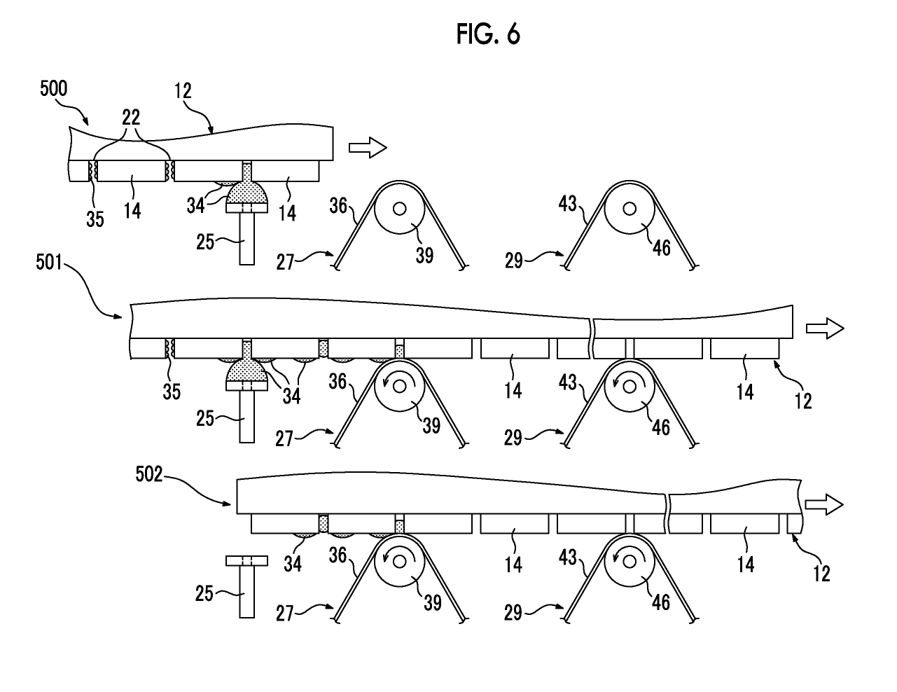

Next, the action of the gap cleaning device 10 having the above-mentioned configuration will be described with reference to FIGS. 5 and 6. In a case in which an operation for starting processing for cleaning the gap 22 between the head module 14 of the ink jet head 12 (for example, an operation for switching the operating mode of the ink jet recording apparatus to a gap maintenance mode) is performed, each unit of the integrated controller 31 starts gap cleaning processing.

First, the movement controller 48 controls the head moving mechanism 24 to convey the ink jet head 12 to the maintenance processing section from the printing section of the ink jet recording apparatus in the head moving direction D2 (Step S1). In this case, the movement controller 48 tracks the position of each gap 22 between the head modules 14 on the basis of information about the position of the ink jet head 12 that is obtained from the conveying speed of the ink jet head 12 conveyed by the head moving mechanism 24 and known dimensions of each part of the ink jet head 12 (Step S2). Then, the movement controller 48 outputs the result of the tracking of the position of each gap 22 to the nozzle controller 49 and the wipe controller 50.

Next, the movement controller 48 determines whether or not the first gap 22 reaches the position where the gap 22 faces the spray nozzle 25 (or a position in the vicinity thereof) on the basis of the result of the tracking of the position of each gap 22 (Step S3). If the first gap 22 reaches a position where the gap 22 faces the spray nozzle 25 as shown by reference numeral 500 of FIG. 6 (YES in Step S3), the movement controller 48 temporarily stops the conveyance of the ink jet head 12, which is performed by the head moving mechanism 24, for the above-mentioned time Ts or reduces the conveying speed of the ink jet head 12 to the above-mentioned speed V (Step S4).

Meanwhile, in case the first gap 22 is moved to a position where the gap 22 faces the spray nozzle 25, the nozzle controller 49 controls the cleaning solution supply mechanism 26 on the basis of the result of the tracking of the position of each gap 22, which is acquired from the movement controller 48, to allow the cleaning solution 34 to be sprayed from the spray nozzle 25. Accordingly, the cleaning solution 34 is sprayed to the first gap 22, which is temporarily stopped or is conveyed so as to decelerate at a position where the gap 22 faces the spray nozzle 25, from the spray nozzle 25 (Step S5). The cleaning solution 34, which is sprayed to the gap 22, is injected into the gap 22 by a capillary force. As a result, the gap 22 is subjected to cleaning processing and mist 35 or the like is removed.

In this case, since the first gap 22 does not reach a position facing each of the first absorption unit 27 and the second absorption unit 29, the wipe controller 50 stops the operation of the first delivering/winding mechanism 37 and the second delivering/winding mechanism 44. That is, Steps S6 and S7 are not performed at this stage.

After the time Ts passes or after the ink jet head 12 is conveyed so as to decelerate for a predetermined amount of time, the movement controller 48 releases the temporary stop of the conveyance of the ink jet head 12 or the deceleration conveyance of the ink jet head 12 and conveys the ink jet head 12 to the maintenance processing section at the original speed (Step S8). Then, the nozzle controller 49 controls the cleaning solution supply mechanism 26 to stop the spray of the cleaning solution 34 from the spray nozzle 25. Since processing for cleaning the other gaps except for the first gap 22 is not completed, the movement controller 48 continues to convey the ink jet head 12 (NO in Step S9).

Hereinafter, whenever the rest of the gaps 22 are sequentially conveyed to a position where the gap 22 faces the spray nozzle 25 as shown by reference numeral 501 of FIG. 6, the processing of the above-mentioned Steps S3 to S5, S8, and S9 is repeatedly performed and the cleaning solution 34 is sprayed to each gap 22 from the spray nozzle 25.

In this case, in case the (n+1)th gap 22 from the downstream side in the head moving direction is temporarily stopped or is conveyed so as to decelerate at a position where the gap 22 faces the spray nozzle 25, the first gap 22, which is present at a position separated from this gap 22 on the downstream side in the head moving direction by a distance of n×P, is temporarily stopped or is conveyed so as to decelerate at a position facing the first absorption unit 27.

The wipe controller 50 operates the first delivering/winding mechanism 37 on the basis of the result of the tracking of the position of each gap 22, which is acquired from the movement controller 48, before a predetermined amount of time from the time when the first gap 22 passes by the first absorption unit 27 (Step S6). Accordingly, while the dry web 36 is pressed against the ink ejection surface 20 or the gap 22 by the pressing roller 39, the dry web 36 is conveyed in a direction opposite to the head moving direction D2 by the first delivering/winding mechanism 37. As a result, the cleaning solution 34, which remains on the ink ejection surface 20 (particularly, the peripheral portion of the gap 22), is wiped off by the dry web 36. Further, the cleaning solution 34 remaining in the first gap 22, which is temporarily stopped or is conveyed so as to decelerate at a position facing the first absorption unit 27, is absorbed into the dry web 36. Since the dry web 36 is used to wipe the cleaning solution 34 off or to absorb the cleaning solution 34, the amount of the cleaning solution 34 to be absorbed and the absorption speed of the cleaning solution 34 can be increased.

Meanwhile, in case the wet web 41 is used instead of the dry web 36, the cleaning solution 34 present in the gap 22 can be reliably absorbed as shown in FIG. 4.

Likewise, when the (n+2)th or subsequent gap 22 from the downstream side in the head moving direction is temporarily stopped or is conveyed so as to decelerate at a position where the gap 22 faces the spray nozzle 25, the spray of the cleaning solution 34 to the gap 22 that is performed by the spray nozzle 25 and the absorption of the cleaning solution 34 of the gap 22 that is performed by the dry web 36 are simultaneously performed in parallel (Steps S3 to S6, S8, and S9).

Further, when the (n+m+1)th or subsequent gap 22 from the downstream side in the head moving direction is temporarily stopped or is conveyed so as to decelerate at a position where the gap 22 faces the spray nozzle 25, the first gap 22, which is present at a position separated from this gap 22 on the downstream side in the head moving direction by a distance of (n+m)×P, is temporarily stopped or is conveyed so as to decelerate at a position facing the second absorption unit 29.

The wipe controller 50 operates the second delivering/winding mechanism 44 on the basis of the result of the tracking of the position of each gap 22, which is acquired from the movement controller 48, before a predetermined amount of time from the time when the first gap 22 passes by the second absorption unit 29 (Step S7). Accordingly, while the wet web 43 is pressed against the ink ejection surface 20 or the gap 22 by the pressing roller 46, the wet web 43 is conveyed in a direction opposite to the head moving direction D2 by the second delivering/winding mechanism 44. As a result, since the finish wiping of the ink ejection surface 20 (particularly, the peripheral portion of the gap 22) is performed by the wet web 43, it is possible to recover the meniscuses of ink that is present in the nozzles 19 provided particularly at the peripheral portion of the gap 22.

Likewise, when the (n+m+2)th or subsequent gap 22 from the downstream side in the head moving direction is temporarily stopped or is conveyed so as to decelerate at a position where the gap 22 faces the spray nozzle 25, the spray of the cleaning solution 34 to the gap 22 that is performed by the spray nozzle 25, the absorption of the cleaning solution 34 of the gap 22 that is performed by the dry web 36, and finish wiping that is performed by the wet web 43 are simultaneously performed in parallel (Steps S3 to S9).

As shown by reference numeral 502 of FIG. 6, the nozzle controller 49 controls the cleaning solution supply mechanism 26 to stop the spray of the cleaning solution 34 from the spray nozzle 25 after the last gap 22 passes by a position where the gap 22 faces the spray nozzle 25. Further, the wipe controller 50 stops the operation of the first delivering/winding mechanism 37 after a predetermined amount of time passes from the time when the last gap 22 passes by the first absorption unit 27; and stops the operation of the second delivering/winding mechanism 44 after a predetermined amount of time passes from the time when the last gap 22 passes by the second absorption unit 29.

The cleaning processing, the absorption processing, the finish wiping of all the gaps 22 are completed as described above, and the gap cleaning processing is ended. The ink jet head 12 having been subjected to the gap cleaning processing is conveyed to maintenance processing by the head moving mechanism 24.

[Effect of Gap Cleaning Device]

Since the gap cleaning device 10 of the invention sprays the cleaning solution 34 to the gap 22 from the spray nozzle 25 in case the gap 22 between the head modules 14 of the ink jet head 12 is present at the position where the gap 22 faces the spray nozzle 25, the gap cleaning device 10 does not need to apply or spray the cleaning solution 34 over the entire ink ejection surface 20. For this reason, the suction of air bubbles or the cleaning solution 34 into the ink jet head 12 is prevented. Further, in the gap cleaning device 10, the first absorption unit 27 and the second absorption unit 29 are disposed at positions that are separated from the spray nozzle 25 on the downstream side in the head moving direction by distances of natural numbers times the pitch of the gaps 22. Accordingly, the spray of the cleaning solution 34 to the gap 22 that is performed by the spray nozzle 25, the absorption of the cleaning solution 34 of the gap 22 that is performed by the dry web 36, and finish wiping that is performed by the wet web 43 can be simultaneously performed in parallel. As a result, it is possible to reduce maintenance time while injecting the cleaning solution 34 into each gap 22 so that air bubbles or the cleaning solution 34 is not sucked into the ink jet head 12.

[Modifications of Spray Nozzle]

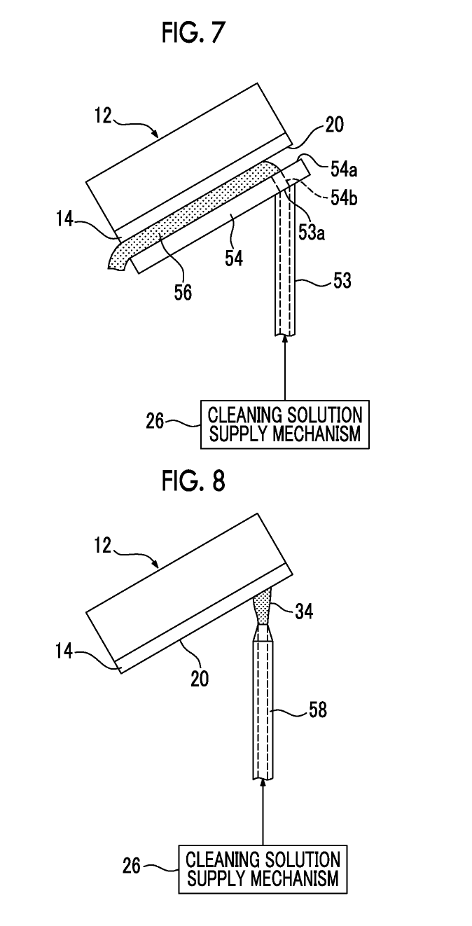

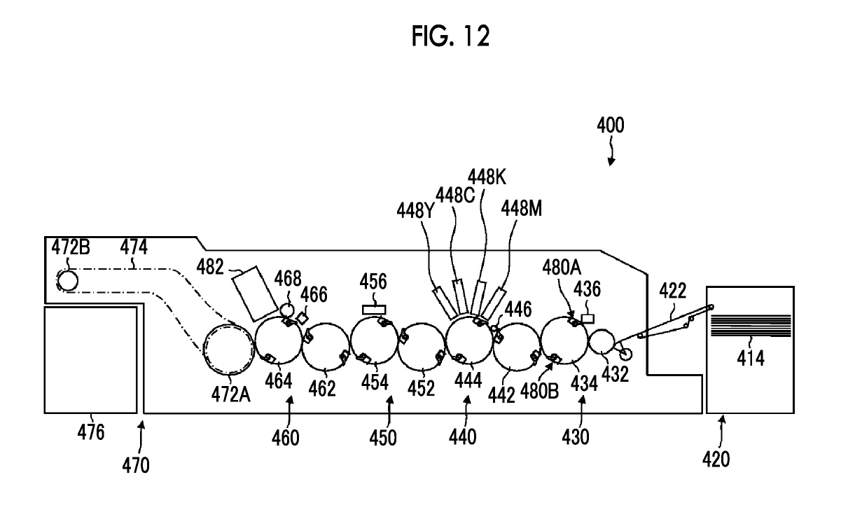

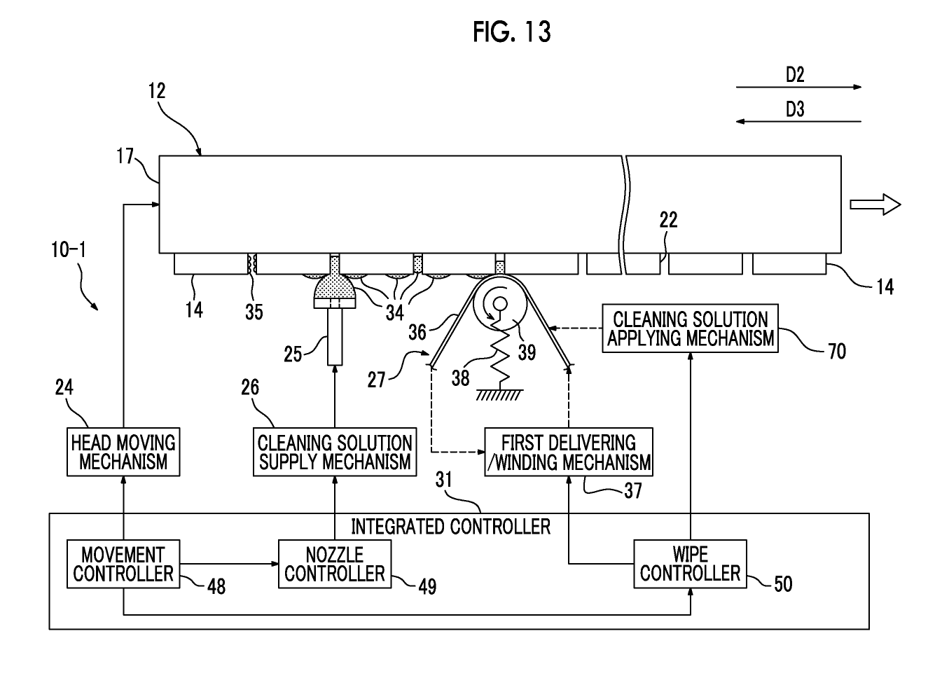

The cleaning solution 34 is sprayed to the gap 22 from the spray nozzle 25 in the embodiment. However, for example, a spray nozzle 53 may be used instead of the spray nozzle 25 as shown in FIG. 7. Meanwhile, a case in which the ink ejection surface 20 of the ink jet head 12 is inclined with respect to a horizontal plane (for example, an ink jet head of an ink jet recording apparatus employing an impression cylinder-conveyance system, see FIG. 12) will be described here by way of example.

A plate-like cleaning solution film-forming portion 54 is provided at a tip portion of the spray nozzle 53. The cleaning solution film-forming portion 54 includes a parallel surface 54a that faces the ink ejection surface 20, is parallel to the ink ejection surface 20, and has a shape corresponding to the gap 22 (see the spray nozzle 25 of FIG. 3). Further, the cleaning solution film-forming portion 54 includes a communication hole 54b that is opened to the parallel surface 54a and communicates with a spray hole 53a of the spray nozzle 53. Accordingly, the cleaning solution 34, which is sprayed from the spray hole 53a of the spray nozzle 53, forms a cleaning solution film 56 while spreading between the parallel surface 54a and the ink ejection surface 20 (gap 22) through the communication hole 54b. Then, the cleaning solution 34 flows down from the upper portion of an inclination along the parallel surface 54a. As a result, the cleaning solution 34 is injected into the gap 22 from the cleaning solution film 56 by a capillary force.

Furthermore, for example, a rod-like spray nozzle 58 may be used instead of the spray nozzles 25 and 53 as shown in FIG. 8 to inject a cleaning solution 34 into the gap 22 using an inertial force by spraying the cleaning solution 34 to one point in the gap 22 (the ink ejection surface 20).

[Example Applied to Ink Jet Recording Apparatus]

Next, an example of the application of the gap cleaning device 10 will be described.

<Entire Configuration>

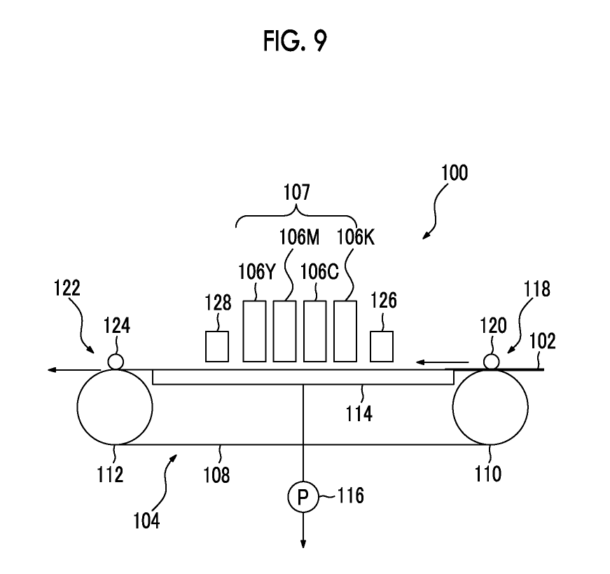

FIG. 9 is a view showing the entire configuration of an ink jet recording apparatus 100 including the gap cleaning device 10. The ink jet recording apparatus 100 shown in FIG. 9 includes: a recording medium conveying section 104 that holds and conveys a recording medium 102; and a printing section 107 that includes ink jet heads 106K, 106C, 106M, and 106Y for ejecting color inks corresponding to K (black), C (cyan), M (magenta), and Y (yellow) to the recording medium 102 held by the recording medium conveying section 104.

The recording medium conveying section 104 includes: an endless conveyor belt 108 of which a recording medium-holding region for holding the recording medium 102 includes a plurality of suction holes (not shown); conveying rollers (a driving roller and a driven roller) 110 and 112 around which the conveyor belt 108 is wound; a chamber 114 that is provided on the back side of the recording medium-holding region of the conveyor belt 108 (the surface opposite to a recording medium-holding surface on which the recording medium 102 is held) and generates negative pressure in the suction holes (not shown) formed in the recording medium-holding region; and a vacuum pump 116 that generates negative pressure in the chamber 114.

A carry-in portion 118 in which the recording medium 102 is carried is provided with a pressing roller 120 that prevents the recording medium 102 from floating. Further, a discharge portion 122 from which the recording medium 102 is discharged is also provided with a pressing roller 124.

Negative pressure is applied to the recording medium 102, which is carried from the carry-in portion 118, from the suction holes formed in the recording medium-holding region, so that the recording medium 102 is held on the recording medium-holding region of the conveyor belt 108.

A temperature regulating unit 126, which regulates the surface temperature of the recording medium 102 in a predetermined range, is provided in front of the printing section 107 (on the upstream side in a recording medium-conveying direction) on a conveying path of the recording medium 102. Further, a reading device (read sensor) 128, which reads an image recorded on the recording medium 102, is provided in the rear of the printing section 107 (on the downstream side in the recording medium-conveying direction).

The recording medium 102, which is carried from the carry-in portion 118, is held on the recording medium-holding region of the conveyor belt 108 by suction, and an image is recorded on the recording medium 102 in the printing section 107 after the recording medium 102 is subjected to temperature regulation processing by the temperature regulating unit 126.

The recording medium 102 on which the image is recorded is discharged to the outside from the discharge portion 122 after the recorded image (test pattern) is read by the reading device 128.

<Configuration of Printing Section>

Each of the ink jet heads 106K, 106C, 106M, and 106Y of the printing section 107 is a full-line type ink jet head in which a plurality of nozzles are disposed over a length longer than the entire width of the recording medium 102. Further, each of the ink jet heads 106K, 106C, 106M, and 106Y has a structure in which a plurality of head modules are joined to each other in a longitudinal direction (see FIGS. 2 and 3).

The ink jet heads 106K, 106C, 106M, and 106Y are disposed in this order from the upstream side in the recording medium-conveying direction. An image can be recorded on the entire area of the recording medium 102 by a single-pass method in which the recording medium 102 is moved relative to the full-line type ink jet heads 106K, 106C, 106M, and 106Y one time.

Meanwhile, the printing section 107 is not limited to the above-mentioned embodiment. For example, the printing section 107 may include an ink jet head corresponding to LC (light cyan) or LM (light magenta). Further, the order in which the ink jet heads 106K, 106C, 106M, and 106Y are disposed can also be appropriately changed.

Furthermore, the ink jet recording apparatus 100 includes an ink supply section (not shown). The ink supply section includes ink tanks that store inks to be supplied to the ink jet heads 106K, 106C, 106M, and 106Y and correspond to the respective colors (the respective heads). The ink tanks corresponding to the respective colors communicate with the ink jet heads 106K, 106C, 106M, and 106Y through ink supply lines (not shown).

Meanwhile, ejection methods of the ink jet heads 106K, 106C, 106M, and 106Y are not particularly limited. A piezoelectric method that uses the bending deformation of a piezoelectric element, a thermal method that uses a film boiling phenomenon of ink, and the like can be applied.

<Description of Maintenance Processing Section>

FIG. 10 is a view showing a disposition relationship between the printing section 107 and a maintenance processing section 130 of the ink jet recording apparatus 100. The maintenance processing section 130 is disposed at a maintenance position that is horizontally moved from an image forming position for the ink jet heads 106K, 106C, 106M, and 106Y on the recording medium conveying section 104 in a direction (the longitudinal direction D1 and the head moving direction D2 having been described above) substantially orthogonal to the conveying direction of the recording medium 102.

The maintenance processing section 130 includes the above-mentioned gap cleaning devices 10, normal cleaning devices 125, and cap units 132 that perform the suction processing and purging processing of the ink jet heads 106K, 106C, 106M, and 106Y The gap cleaning device 10, the normal cleaning device 125, and the cap unit 132, which correspond to one head, are shown in FIG. 10, but the gap cleaning device 10, the normal cleaning device 125, and the cap unit 132 are provided for each ink jet head.

The normal cleaning device 125 removes dirt, which adheres to the ink ejection surface 20, by performing processing for cleaning each of the ink ejection surfaces of the ink jet heads 106K, 106C, 106M, and 106Y. For example, various cleaning devices disclosed in JP2010-5857A, JP2012-157983A, and JP2005-28758A can be used as the normal cleaning device 125. Meanwhile, since the configuration and action of the normal cleaning device 125 are well known, the detailed description thereof will be omitted.

The ink jet recording apparatus 100 selectively performs a normal cleaning processing mode in which processing for cleaning the ink jet heads 106K, 106C, 106M, and 106Y by normal cleaning devices 125 is performed and a gap cleaning processing mode in which processing for cleaning each gap 22 by the gap cleaning device 10 is performed. The normal cleaning processing mode is regularly performed during an interval between jobs, at the time of start of a job, and the like. Further, the gap cleaning processing mode is performed at a frequency lower than the frequency of the normal cleaning processing mode, such as once a week or once a month. Meanwhile, the normal cleaning processing mode or the gap cleaning processing mode may be performed through a user interface (not shown) by an input from an operator.

In order to move the ink jet heads 106K, 106C, 106M, and 106Y to the maintenance position from the image forming position, the ink jet heads 106K, 106C, 106M, and 106Y are temporarily retracted upward from the image forming position on the recording medium conveying section 104 and are horizontally moved in a direction orthogonal to the conveying direction of the recording medium 102. Meanwhile, the above-mentioned head moving mechanism 24 is used as a moving mechanism that moves each of the ink jet heads 106K, 106C, 106M, and 106Y.

In case the ink jet heads 106K, 106C, 106M, and 106Y reach a processing region for the gap cleaning devices 10 at the time of the gap cleaning processing mode, the gap cleaning device 10 is moved up (or the ink jet heads 106K, 106C, 106M, and 106Y are moved down) and processing for cleaning each gap 22 by the gap cleaning device 10 is performed. Further, in case the ink jet heads 106K, 106C, 106M, and 106Y reach a processing region for the normal cleaning devices 125 at the time of the normal cleaning processing mode, the normal cleaning device 125 is moved up (or the ink jet heads 106K, 106C, 106M, and 106Y are moved down) and processing for cleaning the ink ejection surface 20 by the normal cleaning device 125 is performed.

In case the gap cleaning processing or the normal cleaning processing is ended, the ink jet heads 106K, 106C, 106M, and 106Y are moved to a processing region for the cap units 132 and the cap units 132 come into close contact with the ink ejection surfaces 20 and perform suction processing and purging processing.

The cap unit 132 communicates with a waste ink tank 136 through a discharge flow passage 134, and the discharge flow passage 134 is provided with a pump 138. In case the pump 138 is operated while the cap units 132 come into close contact with the ink ejection surfaces 20, inks present in the ink jet heads 106K, 106C, 106M, and 106Y are sucked in through the nozzles.

In case maintenance processing for the ink jet heads 106K, 106C, 106M, and 106Y is ended in this way, the ink jet heads 106K, 106C, 106M, and 106Y are moved to the image forming position.

A horizontal conveying mechanism and a vertical conveying mechanism of a well-known technique can be applied as a moving mechanism that moves each of the ink jet heads 106K, 106C, 106M, and 106Y in a vertical direction and a horizontal direction.

<Configuration of Control System>

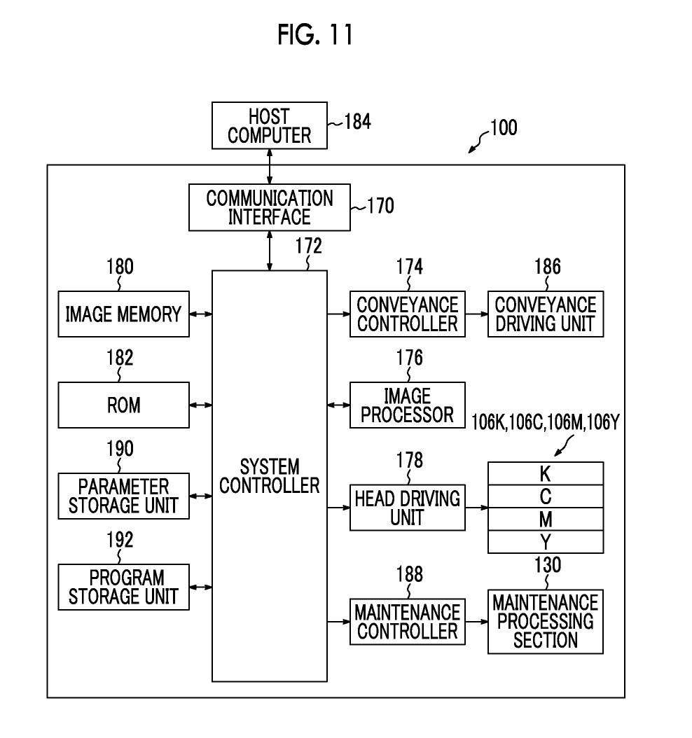

FIG. 11 is a block diagram showing the schematic configuration of a control system of the ink jet recording apparatus 100. As shown in FIG. 11, the ink jet recording apparatus 100 includes a communication interface 170, a system controller 172, a conveyance controller 174, an image processor 176, a head driving unit 178, an image memory 180, and a ROM 182.

The communication interface 170 is an interface unit that receives raster image data sent from a host computer 184. A serial interface, such as a USB (Universal Serial Bus), may be applied as the communication interface 170, and a parallel interface, such as centronics, may be applied as the communication interface 170. A buffer memory (not shown) for increasing the speed of communication may be mounted on the communication interface 170.

The system controller 172 includes a central processing unit (CPU), peripheral circuits thereof, and the like; and functions as a control unit that controls the entire ink jet recording apparatus 100 according to a predetermined program. Further, the system controller 172 functions as an arithmetic unit that performs various operations, and functions as a memory controller for the image memory 180 and the ROM 182.

That is, the system controller 172 controls the respective parts, such as the communication interface 170 and the conveyance controller 174; controls communication between the host computer 184 and itself; controls the reading of the image memory 180 and the ROM 182; and generates control signals that are used to control the above-mentioned respective parts.

Image data sent from the host computer 184 are input to the ink jet recording apparatus 100 through the communication interface 170, and are subjected to predetermined image processing by the image processor 176.

The image processor 176 is a controller that has a signal (image) processing function to perform processing, such as various kinds of processing for generating print control signals from image data and correction and supplies generated print data (dot data) to the head driving unit 178.

In case necessary signal processing is performed in the image processor 176, the amount of liquid droplets to be ejected (the amount of liquid droplets to be dropped) from each of the ink jet heads 106K, 106C, 106M, and 106Y or ejection time is controlled through the head driving unit 178 on the basis of the print data (halftone image data). Meanwhile, the head driving unit 178 may be formed of a plurality of blocks for each head module 14. Accordingly, a desired dot size or desired dot disposition is realized.

The conveyance controller 174 controls the conveying time and the conveying speed of the recording medium 102 on the basis of the print data generated by the image processor 176. A conveyance driving unit 186 includes a motor that drives the driving roller of the recording medium conveying section 104 conveying the recording medium 102, and the conveyance controller 174 functions as a driver of the motor.

The image memory 180 has a function as temporary storage means for temporarily storing image data, which are input through the communication interface 170, and functions as an expansion area for various program stored in the ROM 182 and an arithmetic work area for a CPU (for example, a work area for the image processor 176). A volatile memory (RAM), where data can be sequentially read and written, is used as the image memory 180.

Programs to be executed by the CPU of the system controller 172, various kinds of data required for controlling each part of the apparatus, control parameters, and the like are stored in the ROM 182, and data are read from and written in the ROM 182 through the system controller 172. The ROM 182 is not limited to a memory formed of a semiconductor element, and a magnetic medium, such as a hard disk, may be used as the ROM. Further, an external interface may be provided and a detachable storage medium may be used.

A maintenance controller 188 integrally controls various operations (including an operation for moving the ink jet heads 106K, 106C, 106M, and 106Y by the head moving mechanism 24) of the maintenance processing section 130 that includes the gap cleaning device 10 and the normal cleaning device 125.

Various control parameters required for the operation of the ink jet recording apparatus 100 are stored in a parameter storage unit 190. The system controller 172 appropriately reads parameters, which are required for control, and updates (rewrites) various parameters as necessary.

A program storage unit 192 is storage means for storing a control program that operates the ink jet recording apparatus 100. In case the system controller 172 (or each part of the apparatus) controls each part of the apparatus, a necessary control program is read from the program storage unit 192 and the control program is appropriately executed.

Cleaning processing (maintenance) for each of the ink jet heads 106K, 106C, 106M, and 106Y by the normal cleaning device 125 may be regularly performed during an interval between jobs, at the time of start of a job, and the like; and may be performed through a user interface (not shown) by an input from an operator.

[Example Applied to Another Ink Jet Recording Apparatus]

FIG. 12 is a view showing the entire configuration of an ink jet recording apparatus 400 including the gap cleaning device 10 of the invention. An impression cylinder-conveyance system, which holds a recording medium 414 on the outer peripheral surface of an impression cylinder and conveys the recording medium 414, is applied to the ink jet recording apparatus 400.

Further, ink jet heads 448M, 448K, 448C, and 448Y, which eject inks onto the recording medium 414, are disposed to be inclined with respect to a horizontal plane so that nozzle surfaces of the ink jet heads are orthogonal to a normal of the outer peripheral surface of an impression cylinder (a drawing drum 444).

The ink jet recording apparatus 400 includes a recording medium storage section 420 in which recording media 414 on which images are not yet formed are stored, a treatment liquid applying section 430 that applies treatment liquid to the recording medium 414 sent from the recording medium storage section 420, a drawing section 440 that forms a desired color image by ejecting color inks to the recording medium 414 to which the treatment liquid has been applied, a drying section 450 that dries the recording medium 414 on which the color image has been formed, a fixing section 460 that performs fixing processing on the dried recording medium 414, and a discharge section 470 that discharges the recording medium 414 to which the color image is fixed.

An end portion of the recording medium 414, which is delivered to a transfer cylinder 432 through a sheet feed tray 422, is gripped by grippers 480A and 480B of a treatment liquid cylinder 434; and the recording medium 414 is supported by the treatment liquid cylinder 434 and is conveyed along the outer peripheral surface of the treatment liquid cylinder 434 according to the rotation of the treatment liquid cylinder 434.

In case the recording medium 414, which is rotationally conveyed by the treatment liquid cylinder 434, reaches a processing region for a treatment liquid applying device 436 disposed at a position facing the outer peripheral surface of the treatment liquid cylinder 434, treatment liquid is applied to the surface of the recording medium 414 on which an image is to be formed. The treatment liquid, which is applied by the treatment liquid applying device 436, has a function to react with color inks, which are ejected from the ink jet heads 448M, 448K, 448C, and 448Y, and to allow colorants, which are contained in the color inks, to cohere or to be insolubilized.

The recording medium 414 to which the treatment liquid has been applied is delivered to the drawing drum 444 through the transfer cylinder 442, is held on the outer peripheral surface of the drawing drum 444, and is rotationally conveyed along the outer peripheral surface of the drawing drum 444.

A sheet pressing roller 446 is disposed in front of the ink jet heads 448M, 448K, 448C, and 448Y on the upstream side in a recording medium-conveying direction, and is adapted to allow the recording medium 414 to come into close contact with the outer peripheral surface of the drawing drum 444 by the sheet pressing roller 446 immediately before the recording medium 414 enters gaps formed directly below the ink jet heads 448M, 448K, 448C, and 448Y.

Color inks are ejected onto the recording medium 414, which is rotationally conveyed by the drawing drum 444, from the ink jet heads 448M, 448K, 448C, and 448Y, so that a color image is formed on an image forming surface of the recording medium to which the treatment liquid has been applied.

As shown in FIG. 2 and the like, each of the ink jet heads 448M, 448K, 448C, and 448Y has a structure in which a plurality of head modules 14 are joined to each other in a row in a longitudinal direction of each of the ink jet heads 448M, 448K, 448C, and 448Y.

The recording medium 414 on which the color image has been formed is delivered to a drying cylinder 454 through a transfer cylinder 452, is supported by the outer peripheral surface of the drying cylinder 454, and is rotationally conveyed along the outer peripheral surface of the drying cylinder 454 according to the rotation of the drying cylinder 454.

The recording medium 414, which is rotationally conveyed by the drying cylinder 454, is subjected to drying processing from the drying device 456. Heating performed by a heater, the blowing of drying air (heating air) from a fan, or a combination thereof is applied to the drying processing.

The recording medium 414, which has been subjected to drying processing, is delivered to a fixing cylinder 464 through a transfer cylinder 462. The recording medium 414, which is delivered to the fixing cylinder 464, is held on the outer peripheral surface of the fixing cylinder 464, and is rotationally conveyed along the outer peripheral surface of the fixing cylinder 464 according to the rotation of the fixing cylinder 464.

The image, which is formed on the recording medium 414, which is rotationally conveyed by the fixing cylinder 464, is subjected to heating processing by a heater 466 and is subjected to pressing processing by a fixing roller 468. An in-line sensor 482, which is provided on the downstream side of the fixing roller 468 in the recording medium-conveying direction, is means for imaging the recording medium 414 (image), which has been subjected to fixing processing by heating and pressing, and abnormal ejection of each of the ink jet heads 448M, 448K, 448C, and 448Y is determined on the basis of the result of the imaging of the in-line sensor 482.

The recording medium 414, which has passed through a region imaged by the in-line sensor 482, is sent to the discharge section 470. The discharge section 470 is adapted to convey the recording medium 414 to a stocker 476 by a chain 474 that is wound around tensioning rollers 472A and 472B.

The ink jet recording apparatus 400 includes a maintenance processing section (not shown) that is provided at a position separated from the drawing section 440 in a direction orthogonal to the recording medium-conveying direction (a direction perpendicular to the plane of FIG. 12) and performs maintenance processing for the ink jet heads 448M, 448K, 448C, and 448Y. The maintenance processing section includes a gap cleaning device that has basically the same configuration as the above-mentioned gap cleaning device 10 (see FIGS. 7 and 8) and a normal cleaning device that has basically the same configuration as the normal cleaning device 125. Meanwhile, since cleaning processing, which is performed by the gap cleaning device of the ink jet recording apparatus 400, is basically the same as the cleaning processing that is performed by the gap cleaning device 10 of the first embodiment, the description thereof will be omitted here.

[Others]

In the embodiment, the first absorption unit 27 absorbs and removes the cleaning solution 34, which is present in the gap 22, by using the dry web 36 or the wet web 41. However, the first absorption unit 27 may absorb and remove the cleaning solution 34, which is present in the gap 22, by using various absorption members (first absorption member) that can absorb the cleaning solution 34 like a porous member such as sponge. Further, various removing members, which can remove the cleaning solution 34 present in the gap 22, such as a scraping member for scraping off the cleaning solution 34, which is present in the gap 22, may be used. Furthermore, various absorption members (second absorption member), which are in a wet state, may be used instead of the wet web 43.

In the embodiment, finish wiping is performed by the second absorption unit 29 (the wet web 43) that is disposed on the downstream side of the first absorption unit 27 in the head moving direction D2. However, the second absorption unit 29 may be appropriately omitted.

While each gap 22 passes by the first absorption unit 27 of the embodiment, the first absorption unit 27 allows the dry web 36 or the wet web 41 to always come into contact with the ink ejection surface 20. However, the first absorption unit 27 may not allow the dry web 36 or the wet web 41 to always come into contact with the ink ejection surface 20. For example, the first absorption unit 27 may be provided with a shift mechanism and the like; may allow the dry web 36 or the like to come into contact with the gap 22 in case each gap 22 is conveyed to the position facing the dry web 36 or the like; and may retract the dry web 36 or the like from the ink ejection surface 20 in case the gap 22 is not present at a position facing the dry web 36 or the like.

In the embodiment, the finish wiping of the ink ejection surface 20 is performed by using the wet web 43 of the second absorption unit 29 after the cleaning solution 34 is sprayed to the gap 22 and the cleaning solution 34 present in the gap 22 is removed (absorbed). However, finish wiping may be performed by using the first absorption unit 27 (the dry web 36 or the wet web 41). A gap cleaning device 10-1 (see FIG. 13) of another embodiment, which performs finish wiping by the first absorption unit 27, will be described below. Meanwhile, a case in which the first absorption unit 27 includes the dry web 36 will be described here.

As shown in FIG. 13, the configuration of the gap cleaning device 10-1 is basically the same as that of the gap cleaning device 10 of the embodiment except that a cleaning solution applying mechanism 70 is provided instead of the second absorption unit 29. Components, which are the same as those of the first embodiment in terms of a function and a configuration, are denoted by the same reference numerals and the description thereof will be omitted. However, at the time of processing for cleaning the gap 22, the head moving mechanism 24 moves the ink jet head 12 in the head moving direction D2 and in a head moving direction D3 (the other direction) opposite to the head moving direction D2 under the control of the movement controller 48. That is, the ink jet head 12 can be relatively moved in the head moving direction D2 and the head moving direction D3.

The movement controller 48 controls the head moving mechanism 24 to convey the ink jet head 12 in the head moving direction D2 first and to convey the ink jet head 12 in the head moving direction D3 after the last gap 22 passes by the first absorption unit 27. Further, after the first gap 22 passes by the first absorption unit 27, the movement controller 48 controls the head moving mechanism 24 to convey the ink jet head 12 in the head moving direction D2 again.

The cleaning solution applying mechanism 70 forms a wipe controller of the invention together with the wipe controller 50, and supplies liquid, such as the cleaning solution 34, to the dry web 36, which does not yet come into contact with the ink ejection surface 20, under the control of the wipe controller 50.

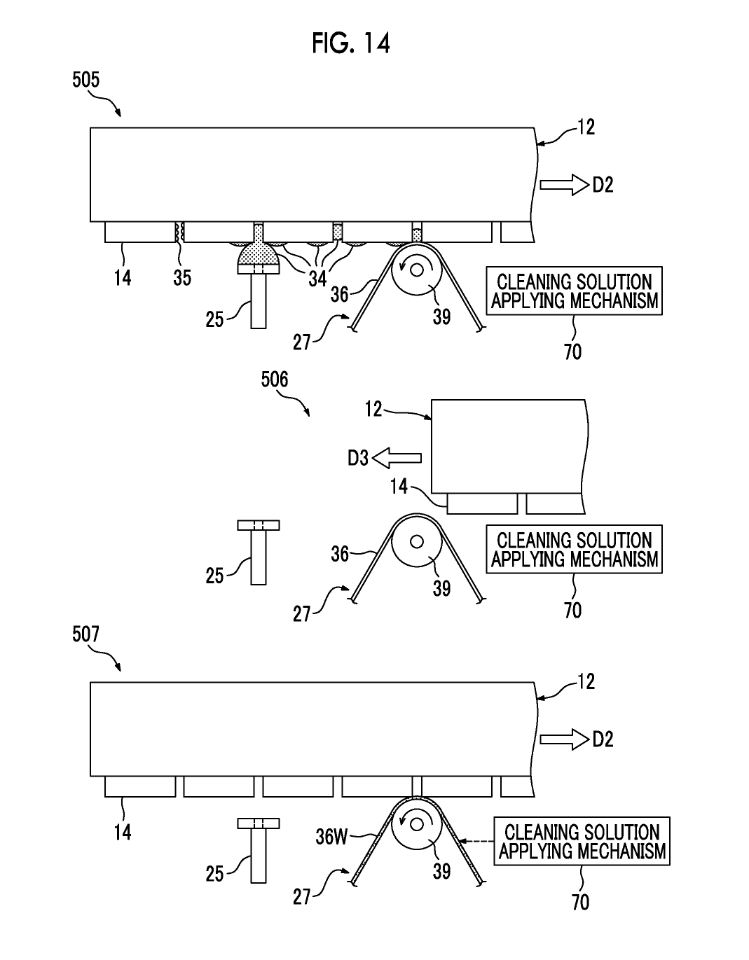

The wipe controller 50 supplies liquid to the dry web 36 from the cleaning solution applying mechanism 70 before the ink jet head 12 is conveyed in the head moving direction D2 again. Accordingly, since the dry web 36 becomes a wet web 36W (see FIG. 14), the ink ejection surface 20 of the ink jet head 12, which is conveyed in the head moving direction D2 again, is subjected to finish wiping by the wet web 36W.

Next, the action of the gap cleaning device 10-1 having the above-mentioned configuration will be described with reference to FIG. 14. As shown by reference numeral 505, the movement controller 48 controls the head moving mechanism 24 to convey the ink jet head 12 in the head moving direction D2 in the same manner as in the gap cleaning device 10 of the embodiment after the start of the gap cleaning processing. Further, the nozzle controller 49 controls the cleaning solution supply mechanism 26 to spray the cleaning solution 34 to the gap 22 from the spray nozzle 25, and the wipe controller 50 controls the first absorption unit 27 to absorb the cleaning solution 34, which is present in the gap 22, by the dry web 36. Then, the spray of the cleaning solution from the spray nozzle 25 and the conveyance of the dry web 36 are stopped at the time in case the last gap 22 passes by the spray nozzle 25 and the first absorption unit 27.

As shown by reference numeral 506, the movement controller 48 controls the head moving mechanism 24 to convey the ink jet head 12 in the head moving direction D3 after the last gap 22 passes by the first absorption unit 27. Meanwhile, while the ink jet head 12 is conveyed in the head moving direction D3, the wipe controller 50 may control a shift mechanism (not shown) to retract the first absorption unit 27 from a position where the first absorption unit 27 comes into contact with the ink ejection surface 20.

As shown by reference numeral 507, the movement controller 48 controls the head moving mechanism 24 to convey the ink jet head 12 in the head moving direction D2 again after the first gap 22 passes by the first absorption unit 27.

Further, the wipe controller 50 starts to supply liquid to the dry web 36 by the cleaning solution applying mechanism 70 and controls the first delivering/winding mechanism 37 to start to convey the dry web 36 before the ink jet head 12 is conveyed in the head moving direction D2 again. Accordingly, wipe can be performed by the wet web 36W.

The ink jet head 12 is conveyed in the head moving direction D2 and the ink ejection surface 20 (particularly, the peripheral portion of the gap 22) is subjected to finish wiping by the wet web 36W. Accordingly, it is possible to recover the meniscuses of ink that is present in the nozzles 19 provided particularly at the peripheral portion of the gap 22 as in the embodiment.

Meanwhile, in case the first absorption unit 27 includes the wet web 41 shown in FIG. 4, the cleaning solution applying mechanism 70 is not necessary. Accordingly, the wipe controller 50 performs the finish wiping of the ink ejection surface 20 (particularly, the peripheral portion of the gap 22) by using the wet web 41 just as it is as shown in FIG. 14.

### EXPLANATION OF REFERENCES

10: gap cleaning device
12: ink jet head
14: head module
19: nozzle
22: gap
24: head moving mechanism
26: cleaning solution supply mechanism
27: first absorption unit
29: second absorption unit
34: cleaning solution
36: dry web
41: wet web
48: movement controller
49: nozzle controller

What is claimed is:

1. A cleaning device comprising:
a spray nozzle that sprays a cleaning solution to an ink ejection surface of an ink jet head in which a plurality of head modules are joined to each other in one direction;
a relative movement unit that moves the position of the ink jet head relative to the spray nozzle in the one direction;
a movement controller that temporarily stops relative movement performed by the relative movement unit or reduces moving speed of the relative movement at a position where a gap between the head modules faces at least the spray nozzle in a case in which the relative movement performed by the relative movement unit is performed;
a nozzle controller that allows the cleaning solution to be sprayed to the gap from the spray nozzle at a time in a case in which the relative movement performed by the relative movement unit is temporarily stopped or at a time in a case in which the moving speed of the relative movement is reduced; and
a removing member that is disposed at a position separated from the spray nozzle in the one direction by a distance of n times a pitch of the gaps in a case in which n is a natural number of 1 or more, and removes the cleaning solution present in the gap.

2. The cleaning device according to claim 1,
wherein the movement controller temporarily stops the relative movement performed by the relative movement unit at a position where the gap faces the removing member or reduces the moving speed of the relative movement performed by the relative movement unit at the position where the gap faces the removing member.

3. The cleaning device according to claim 1,
wherein the removing member is a first absorption member that comes into contact with the ink ejection surface and absorbs the cleaning solution present in at least the gap.

4. The cleaning device according to claim 2,
wherein the removing member is a first absorption member that comes into contact with the ink ejection surface and absorbs the cleaning solution present in at least the gap.

5. The cleaning device according to claim 3,
wherein the first absorption member is in a dry state.

6. The cleaning device according to claim 4,
wherein the first absorption member is in a dry state.

7. The cleaning device according to claim 3,
wherein the first absorption member is in a wet state.

8. The cleaning device according to claim 4,
wherein the first absorption member is in a wet state.

9. The cleaning device according to claim 3,
wherein in a case in which the period of time during which the first absorption member comes into contact with the gap is denoted by T, the period of time during which the relative movement is temporarily stopped is denoted by Ts, an absorption volume of the cleaning solution, which is absorbed into the first absorption member per unit time, is denoted by Qs, and the volume of the cleaning solution present in the gap is denoted by Qg in a case in which the movement controller temporarily stops the relative movement that is performed by the relative movement unit, the movement controller controls the relative movement unit so that “T=Ts≧(Qg/Qs)” is satisfied.

10. The cleaning device according to claim 4,
wherein in a case in which the period of time during which the first absorption member comes into contact with the gap is denoted by T, the period of time during which the relative movement is temporarily stopped is denoted by Ts, an absorption volume of the cleaning solution, which is absorbed into the first absorption member per unit time, is denoted by Qs, and the volume of the cleaning solution present in the gap is denoted by Qg in a case in which the movement controller temporarily stops the relative movement that is performed by the relative movement unit, the movement controller controls the relative movement unit so that “T=Ts≧(Qg/Qs)” is satisfied.

11. The cleaning device according to claim 3,
wherein in a case in which the period of time during which the first absorption member comes into contact with the gap is denoted by T, the moving speed of the relative movement at the time of deceleration is denoted by V, and a width of the gap in the one direction is denoted by W in a case in which the movement controller reduces the moving speed of the relative movement that is performed by the relative movement unit, the movement controller controls the relative movement unit so that “T=(W/V)≧(Qg/Qs)” is satisfied.

12. The cleaning device according to claim 4,
wherein in a case in which the period of time during which the first absorption member comes into contact with the gap is denoted by T, the moving speed of the relative movement at the time of deceleration is denoted by V, and a width of the gap in the one direction is denoted by W in a case in which the movement controller reduces the moving speed of the relative movement that is performed by the relative movement unit, the movement controller controls the relative movement unit so that “T=(W/V)≧(Qg/Qs)” is satisfied.

13. The cleaning device according to claim 1, further comprising:
a second absorption member that is disposed at a position separated from the removing member in the one direction by a distance of m times the pitch in a case in which m is a natural number of 1 or more, comes into contact with the ink ejection surface, and is in a wet state.

14. The cleaning device according to claim 2, further comprising:
a second absorption member that is disposed at a position separated from the removing member in the one direction by a distance of m times the pitch in a case in which m is a natural number of 1 or more, comes into contact with the ink ejection surface, and is in a wet state.

15. The cleaning device according to claim 3,
wherein the relative movement unit moves the position of the ink jet head relative to the spray nozzle in the one direction and the other direction opposite to the one direction,
the cleaning device further comprises a wipe controller that allows the first absorption member to come into contact with the ink ejection surface after making the first absorption member be in a wet state in a case in which the first absorption member is in a dry state and allows the first absorption member to come into contact with the ink ejection surface in a case a in which the first absorption member is in a wet state, after the cleaning solution is sprayed to the gap by the spray nozzle and the cleaning solution present in the gap is removed by the first absorption member, and
the movement controller performs the relative movement performed by the relative movement unit while the first absorption member being in a wet state comes into contact with the ink ejection surface after the cleaning solution is sprayed to the gap by the spray nozzle and the cleaning solution present in the gap is removed by the first absorption member.

16. The cleaning device according to claim 1, further comprising:
a cleaning solution film-forming portion that is provided at a tip portion of the spray nozzle, including a parallel surface that faces the ink ejection surface, is parallel to the ink ejection surface, and has a shape corresponding to the gap, and a communication hole that is opened to the parallel surface and communicates with a spray hole of the spray nozzle for the cleaning solution, and forming a film of the cleaning solution between the ink ejection surface and the parallel surface in a case in which the cleaning solution is sprayed from the spray hole.

17. The cleaning device according to claim 2, further comprising:
a cleaning solution film-forming portion that is provided at a tip portion of the spray nozzle, n including a parallel surface that faces the ink ejection surface, is parallel to the ink ejection surface, and has a shape corresponding to the gap, and a communication hole that is opened to the parallel surface and communicates with a spray hole of the spray nozzle for the cleaning solution, and forming a film of the cleaning solution between the ink ejection surface and the parallel surface in a case in which the cleaning solution is sprayed from the spray hole.

18. The cleaning device according to claim 1,
wherein the spray nozzle includes one spray hole spraying the cleaning solution and sprays the cleaning solution to one point in the gap from the spray hole.

19. The cleaning device according to claim 2,
wherein the spray nozzle includes one spray hole spraying the cleaning solution and sprays the cleaning solution to one point in the gap from the spray hole.

20. The cleaning device according to claim 1,
wherein a plurality of spray holes, which spray the cleaning solution, are formed at the spray nozzle in a direction parallel to the gap.
